(19) United States
(12) Patent Application Publication
(10) Pub. No.: US 2007/0222963 A1
(43) Pub. Date: Sep. 27, 2007

(54) ILLUMINATION APPARATUS, EXPOSURE APPARATUS HAVING THE SAME, AND DEVICE MANUFACTURING METHOD

(76) Inventor: Yoshio GOTO, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/690,315

(22) Filed: Mar. 23, 2007

(30) Foreign Application Priority Data
Mar. 24, 2006 (JP) 2006-083485

(51) Int. Cl. G03B 27/72; G03B 27/54

(52) U.S. Cl. 355/71; 355/67

(57) ABSTRACT

An illumination optical system for illuminating a target plane using light from a light source includes a waveplate that changes a polarization state of the light, wherein 2.5×10⁻⁷>Δn×d/λ×(sin² θ×cos 2θ/cos³ θ)>0 is met where λ (nm) is a wavelength of the light, θ is an incident angle of the light incident upon the waveplate, Δn (nm/cm) is birefringence of the waveplate, and d (mm) is a thickness of the waveplate.

### BACKGROUND OF THE INVENTION

The present invention relates generally to an illumination optical system and an exposure apparatus.

A projection exposure apparatus has conventionally been used to project and transfer a circuit pattern of a reticle onto a wafer via a projection optical system in manufacturing a semiconductor device using the photolithography technology.

Along with demands for finer processing to semiconductor devices, one recently developed exposure apparatus can expose a pattern smaller than a size of half an exposure wavelength or achieve a high resolution. In general, the high resolution is achieved through use of a short wavelength and/or a projection optical system having a high numerical aperture (“NA”). The high NA of the projection optical system means an increase of an angle between a perpendicular to an image plane and an incident light's traveling direction, and is referred to as high NA imaging.

A polarization of the exposure light poses a problem in exposure with the high NA imaging. For example, assume a so-called line and space (“L & S”) pattern in which a line and a space are repeated. The L & S pattern is exposed through the plane-wave two-beam interference. An incident plane is now defined as a plane that includes an incident direction vector of two beams. The s-polarized light is defined as the polarized light that is perpendicular to the incident plane, and the p-polarized light is the polarized light that is parallel to the incident plane. When an angle between the incident direction vectors of two beams forms 90°, the s-polarized beams interfere with each other, forming a light intensity distribution corresponding to the L & S pattern on the image plane. On the contrary, the p-polarized beams does not interfere with each other (because the interference effect is cancelled out), making constant the light intensity distribution, and providing no light intensity distribution corresponding to the L & S pattern on the image plane. When the s-polarized light and the p-polarized light are mixed, the light intensity distribution on the image plane has a contrast worse than that with only the s-polarized light. As a ratio of the p-polarized light increases, the contrast of the light intensity distribution on the image plane lowers, and finally no pattern is formed.

Hence, control over the polarization of the exposure light is necessary, and a fundamental experiment is performed. In general, the polarization of the exposure light is controlled on a pupil plane in an illumination optical system and/or on a pupil plane of a projection optical system. The exposure light having a polarization controlled on the pupil plane of the illumination optical system illuminates a reticle via the optical system subsequent to the pupil plane in the illumination optical system, and is condensed by the projection optical system and imaged on the image plane. The polarization-controlled exposure light can form a light intensity distribution having an ample contrast on the image plane, and expose a finer pattern. For example, one proposed exposure apparatus has a waveplate that controls a polarization state of the light from a light source to a desired one, and achieves a high resolution by illuminating the reticle using the light having a desired polarization. See PCT International Publication No. 2004/051717.

However, an actual exposure optical system, such as an illumination optical system and a projection optical system, has various factors of deteriorating the ideal polarization state. These factors include a deterioration of a polarization state of the light from the light, the intrinsic birefringence (“IBR”) of a glass material, such as quartz and calcium fluoride, used for the exposure optical system, the stress birefringence that occurs due to the mechanical pressure, and a phase characteristic of an optical film, such as an antireflection film and a reflection film. As a high NA scheme proceeds, a phase error of the waveplate relative to the light having an angular distribution accounts for a large ratio of the factor. Due to these factors, even when the light from the light source is linearly polarized light close to ideal one, a polarization state of each ray shifts on the wafer plane.

In order to obtain a desired polarization state on the wafer plane, the above factor needs to be maintained as low as possible. However, the above reference does not propose any specific measure to the phase error of the waveplate. In other words, if a waveplate that controls a polarization is thick, the above reference cannot control the light having an angular distribution to a desired polarization state.

### SUMMARY OF THE INVENTION

The present invention is directed to an illumination optical system that can maintain a polarization state on a target plane to a desired state, and can precisely control a polarization state of the light having an angular distribution.

An illumination optical system for illuminating a target plane using light from a light source includes a waveplate that changes a polarization state of the light, wherein 2.5×10⁻⁷>Δn×d/λ×(sin² ×cos 2θ/cos³ θ)>0 is met where λ (nm) is a wavelength of the light, θ is an incident angle of the light incident upon the waveplate, Δn (nm/cm) is birefringence of the waveplate, and d (mm) is a thickness of the waveplate.

Other objects and further features of the present invention will become readily apparent from the following description of the preferred embodiments with reference to accompanying drawings.

### BRIEF DESCRIPTION OF THE DRAWINGS

FIG. 1 is a schematic sectional view showing a structure of an exposure apparatus according to one aspect of the present invention.

FIG. 2 is a schematic sectional view showing one illustrative structure of a deflection system in an exposure apparatus shown in FIG. 1.

FIGS. 3A and 3B are schematic sectional and front views of a waveplate in the illumination optical system shown in FIG. 1.

FIGS. 4A-4C show a relationship between a fast axis direction (position) of the waveplate and a polarization state of the exited light when the x-polarized light is incident.

FIG. 5 is a view for explaining a relationship between a thickness of the waveplate and a polarization degree.

FIG. 6 is a view showing a relationship between the thickness of the waveplate shown in FIG. 5 and the polarization degree.

FIG. 7 is a graph showing a relationship between the thickness of the waveplate usable for the exposure apparatus shown in FIG. 1 and the incident angle.

FIG. 8 is a graph showing a relationship between the thickness of the waveplate usable for the exposure apparatus shown in FIG. 1 and the incident angle when sapphire is used for a glass material of the waveplate.

FIG. 9 is a schematic sectional view showing one illustrative structure of a light shaping unit in the exposure apparatus shown in FIG. 1.

FIGS. 10A and 10B are schematic front views showing one illustrative structure of the waveplate of the exposure apparatus shown in FIG. 1.

FIGS. 11A and 11B are schematic front views showing one illustrative structure of the waveplate of the exposure apparatus shown in FIG. 1.

FIGS. 12A to 12C are graphs of a change of each characteristic, such as a contrast, a lateral critical dimension (“CD”) difference, and an axial-off-axial CD difference, when the birefringence of a glass material subsequent to the effective light source forming unit in the exposure apparatus shown in FIG. 1.

FIG. 13 is a view for explaining the intrinsic birefringence of calcium fluoride.

FIGS. 14A and 14B are views for explaining a polarization shift in the intrinsic birefringence when the rotating direction of calcium fluoride is not optimized.

FIGS. 15A and 15B are views for explaining a polarization shift of the intrinsic birefringence when the rotating direction of calcium fluoride is optimized.

FIGS. 16A and 16B are views for explaining a correlation between an inclination angle error and a polarization shift amount when calcium fluoride has an inclination angle error.

FIGS. 17A and 17B are views for explaining a correlation between a rotating angle error and a polarization shift amount when calcium fluoride has a rotating angle error.

FIGS. 18A and 18B are graphs showing a relationship between a phase difference and an incident angle of a narrowband high-reflection (“NBHR”) coating or a broadband high-reflection (“BBHR”) coating.

FIGS. 19A and 19B are views showing a polarization shift to each polarization direction of an incident angle of the NBHR coating or the BBHR coating.

FIG. 20 is a graph showing a relationship between an incident angle of a transmission film and a phase difference.

FIG. 21 is a view showing a result of a polarization shift in a pupil to each polarization direction of a transmission film (x-polarized light, y-polarized light, 45°-polarized light, and −45°-polarized light) estimated at image points (0, 0), (13, 0), and (13, 4.5) on a wafer plane.

FIG. 22 is a view for explaining definitions of the polarization degree and the polarization shift amount.

FIG. 23 is a device manufacturing flowchart.

FIG. 24 is a detailed flowchart of step 4 in FIG. 23.

### DESCRIPTION OF THE EMBODIMENTS

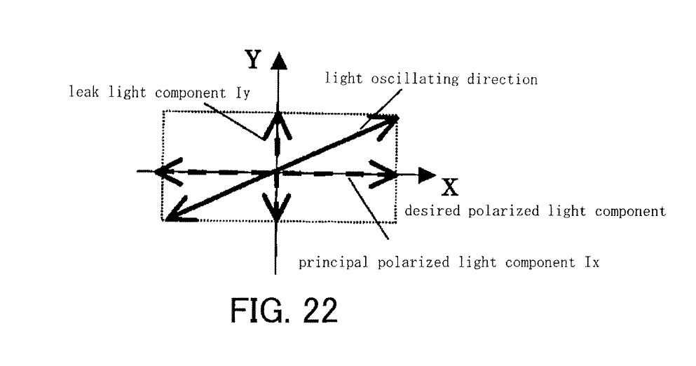

An amount of a polarization degree will now be defined as an index of the polarization illumination performance. FIG. 22 is a view for explaining definitions of a polarization degree and a polarization shift amount. FIG. 22 shows the light that has an electric field vector oscillation plane that shifts from the X-axis direction that is a desired polarization direction. In FIG. 22, Ix is an intensity of a (principal polarized) light component having an electric field vector oscillates in the X-axis direction as the desired polarization direction. Iy is an intensity of a (leak) light component having an electric field vector oscillates in the Y-axis direction orthogonal to the X-axis direction as the desired polarization direction. The polarization degree is defined as Ix/(Ix+Iy). An amount by which the polarization degree shifts, i.e., a polarization shift amount, is defined as (1−Ix/(Ix+Iy)). As the polarization degree is large or the polarization shift amount is small, the contrast improves, sufficiently providing a polarization illumination effect. On the other hand, as the polarization degree is small or the polarization shift amount is large, the contrast lowers, reducing the polarization illumination effect.

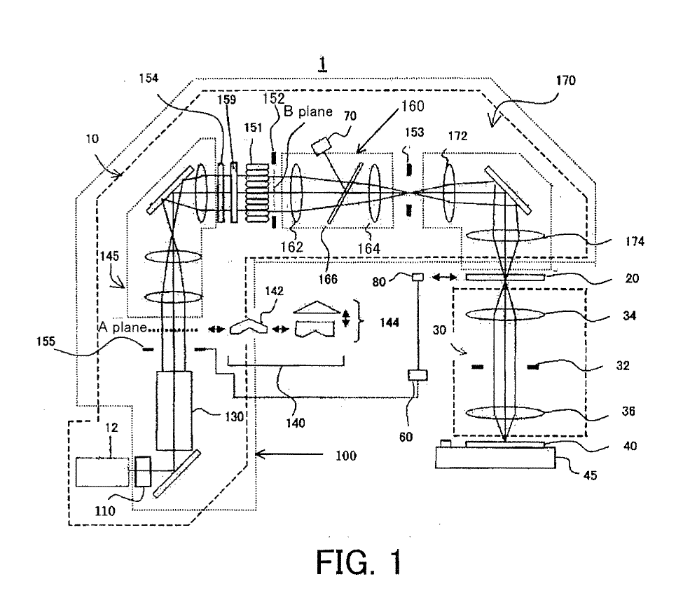

A description will now be given of the exposure apparatus according to one aspect of the present invention. In each figure, the same elements are designated by the same reference numerals, and a duplicate description will be omitted. Here, FIG. 1 is a schematic sectional view showing a structure of an exposure apparatus 1 according to the present invention.

The exposure apparatus 1 is a projection exposure apparatus that exposes a circuit pattern of a reticle 20 onto a wafer 40 as a substrate using a step-and-scan manner or a step-and-repeat manner. This embodiment will now discuss the step-and-scan manner.

The exposure apparatus includes, as shown in FIG. 1, an illumination apparatus 10, a reticle stage mounted with the reticle 20, a projection optical system 30, a wafer stage 45 mounted with a wafer 40, a controller 60, and detectors 70 and 80.

The illumination apparatus 10 illuminates the reticle 20 as a target plane having a circuit pattern to be transferred, and includes a light source 12 and an illumination optical system 100.

The light source 12 preferably emits a laser beam having a polarization degree of 95% or greater in the polarization illumination. Therefore, the light source 12 uses an ArF excimer laser having a wavelength of about 193 nm, or a KrF excimer laser having a wavelength of about 248 nm. However, a type of the light source is not limited to the excimer laser, and the light source can use an F₂ laser having a wavelength of about 157 nm. The number of light sources is not also limited.

The illumination optical system 100 is an optical system configured to illuminate the reticle 20, and includes a lens, a mirror, an optical integrator, and a stop. The illumination optical system 100 of this embodiment includes a deflection system 110, a light shaping unit 130, a light converter 140, an imaging optical system 145, a condenser optical system 160, and an imaging optical system 170. The illumination optical system 100 includes a fly-eye lens 151, a stop 152, a masking blade 153, a filter member 154, a σ shape correction mechanism 155, and a waveplate 159.

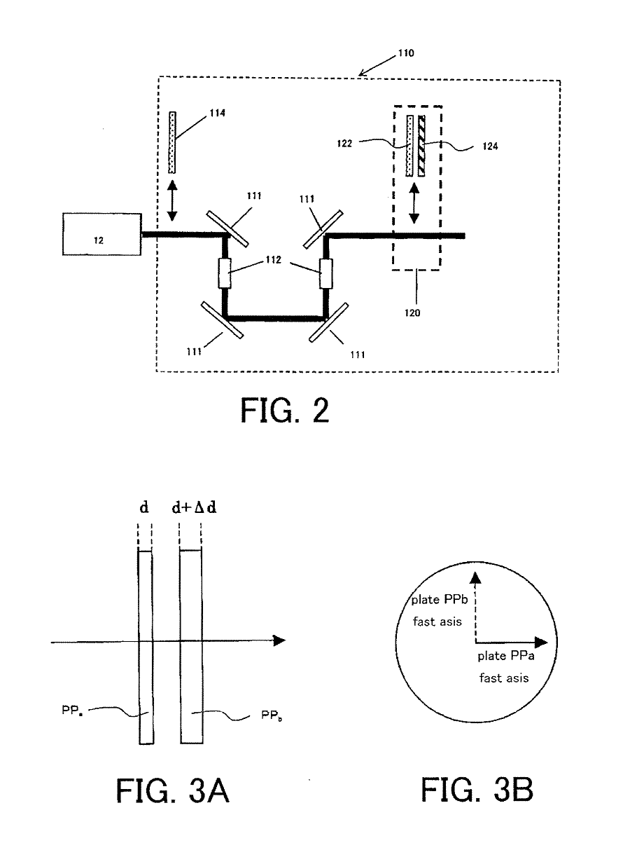

FIG. 2 is a schematic sectional view of one illustrative structure of the deflection system 110. The defection system 110 includes a deflection mirror 111, a cylindrical lens 112, a waveplate 114, and a polarization adjusting mechanism 120. The polarization adjusting mechanism 120 includes and optionally arranges a waveplate 122, a depolarization plate 124, and an aperture plate on an optical path of the light from the light source 12 (an optical path of the illumination optical system 100).

In the deflection system 110, the approximately polarized light emitted from the light source 12 is deflected by the deflection mirror 111, converted into the light having a desired shape or size, such as a circular shape or a square shape, by the cylindrical lens 112, and introduced to the light shaping unit 130.

In order to correct an optical axis shift, the deflection system 110 is configured to incline the deflection mirror 111 and decenter the cylindrical lens 112. The defection system 110 of this embodiment deflects the incident light four times. Nevertheless, depending upon the arrangement of the light source 12 and the illumination optical system 100, various deflecting structures (in the number of deflections and the deflecting manner) are applicable.

The polarization state of the light incident upon the deflection mirror 111 may be the s-polarized light or the p-polarized light depending upon the deflecting manner. In general, a mirror has a reflectance to the s-polarized light higher than that to the p-polarized light. Thus, when the light incident upon the mirror or the light reflected on the mirror is the s-polarized light, the luminance and the throughput improve advantageously.

Accordingly, when the deflection system 110 frequently reflects the p-polarized light, this embodiment arranges the waveplate 114 at the incidence entrance of the light from the light source 12, as shown in FIG. 2, so as to increase reflections of the s-polarized light. The waveplate may be arranged before each deflection mirror so that the s-polarized light is incident upon each deflection mirror. However, the waveplate does not possess a transmittance of 100%, and it is ineffective to arrange the waveplates before each of all the deflection mirrors. Hence, an arrangement of the waveplate 114 at one incident entrance is enough so that the number of deflection mirrors that reflect the s-polarized light increases.

The polarization state of the light incident upon the light shaping unit 130 is adjusted by the deflection system 110 (waveplate 114). The polarization state of the light incident upon the light shape unit 130 needs to be adjusted in accordance with a type of the polarization illumination, such as a tangential polarization and a radial polarization. Accordingly, the deflection system 110 selects whether the waveplate 122 of the polarization adjusting mechanism 120 is inserted into or removed from the optical path so as to freely adjust the polarization state of the light incident upon the light shaping unit 130. For example, the waveplate 122 may use a half waveplate to introduce the polarized light having a desired polarization direction to the light shaping unit 130. Alternatively, the waveplate 122 may use a quarter waveplate.

The waveplate 122 is configured rotatable, and is also used for a fine adjustment of the polarization degree. As described later, when the detector 70 indirectly detects the exposure dose, two polarization states are necessary. These two polarization states can be formed by rotating the waveplate 122. In the random polarization illumination, the deflection system 110 arranges the depolarization plate 124 of the polarization adjusting mechanism 129 on the optical path of the light from the light source (or switches the waveplate 122 to the depolarization plate 124).

A description will now be given of structures of the waveplates 114, 122 and 159 in the illumination apparatus 10 (which will be referred to as a “waveplate of this embodiment”). FIGS. 3A and 3B are views showing the waveplate of this embodiment. More specifically, FIG. 3A is a schematic sectional view of the waveplate of this embodiment. FIG. 3B is a schematic front view of the waveplate of this embodiment.

The waveplate of this embodiment is a 0-th order waveplate that includes two plates PPa and PPb made of uniaxial crystalline, such as MgF₂ and quarts, as shown in FIG. 3A. A n-th order waveplate made of one plate may also be used. There is a glass material thickness difference Ad between the thickness of the plate PPa and the thickness of the plate PPb so that a relative phase difference becomes λ/2 between the fast axis direction and the slow axis direction when the light is incident perpendicularly. This embodiment sets the thickness of the plate PPa to d, and the thickness of the plate PPb to d+Δd. When the thicknesses of the PPa and PPb shift by several micrometers, the phase difference significantly changes and a glass material thickness difference Δd that is a thickness difference between the plate PPa and the plate PPb needs to be precisely formed. FIG. 3B shows the waveplate shown in FIG. 3A when it is viewed from the optical axis direction of the illumination optical system. In FIG. 3B, the solid arrow denotes the fast axis direction of the plate PPa, and the broken arrow denotes the fast axis direction of the plate PPb. The waveplate of this embodiment is arranged while an angle between the fast axes of the plates PPa and PPb maintains 90°.

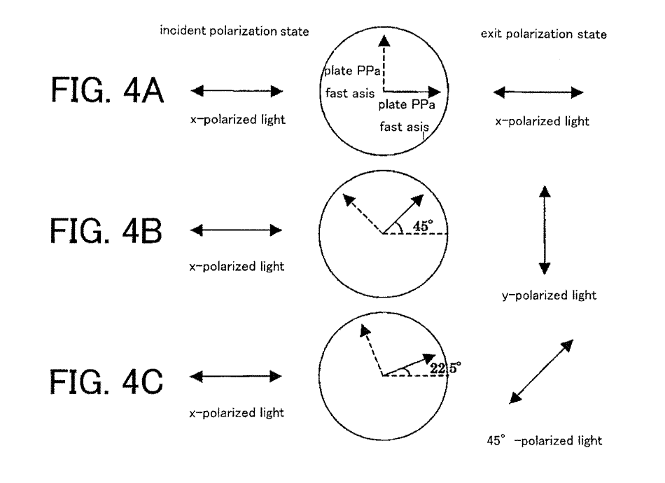

FIGS. 4A and 4B show a relationship between the fast axis direction (position) of the waveplate and the polarization state of the exited light exited when the light of the x-polarized light is incident upon the waveplate of this embodiment. As shown FIG. 4A, the x-polarized light is exited when the waveplate is arranged so that the fast axis direction of the plate PPa heads towards 0° relative to the polarization direction (x-polarized light) of the incident light. As shown in FIG. 4B, the y-polarized light is exited when the waveplate is arranged so that the fast axis direction of the plate PPa heads towards 45° relative to the polarization direction of the incident light. As shown in FIG. 4C, the 45°-polarized light is exited when the waveplate is arranged so that the fast axis direction of the plate PPa heads towards 22.5° relative to the polarization direction of the incident light.

In particular, in a high-NA exposure apparatus 1, the light having a predetermined angular distribution rather than the parallel light is incident upon the waveplate. In general, the thicknesses d and d+Δd of two waveplates are set to the 0-th order waveplate made of two uniaxial crystalline plates to the perpendicularly incident light (having a wavelength λ) so as to provide a predetermined phase difference. For the light having an angle θ incident upon the waveplate, an optical path length in the waveplate is longer than the light that is perpendicularly incident upon the waveplate. As a result, the light after passing the two waveplates (birefringence Δn) contains a phase error Δ defined by Equation 1 below. In other words, the waveplate cannot provide a predetermined phase difference to the light having an angular distribution. Birefringence is a phase difference when the light travels by a unit length.

$$Δ = \frac{Δ n \times d}{λ} \times ( {sin}^{2} θ \times cos 2 θ / {cos}^{3} θ ) \qquad EQUATION 1$$

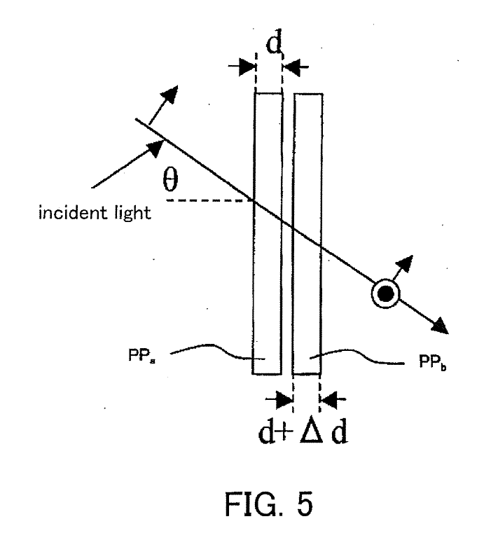

Now, as shown in FIG. 5, assume the waveplate (0-th order half waveplate) that consists of two quartz plates PPa and PPb. Quartz is a birefringent glass material, and has birefringence Δn of 0.01364 nm/cm. The polarization degree is defined as Ix/(Ix+Iy). Ix is an intensity of the light whose electric field vector oscillates in a direction perpendicular to the paper plane shown in FIG. 5. Iy is an intensity of the light whose field vector oscillates in a direction parallel to the paper plane shown in FIG. 5.

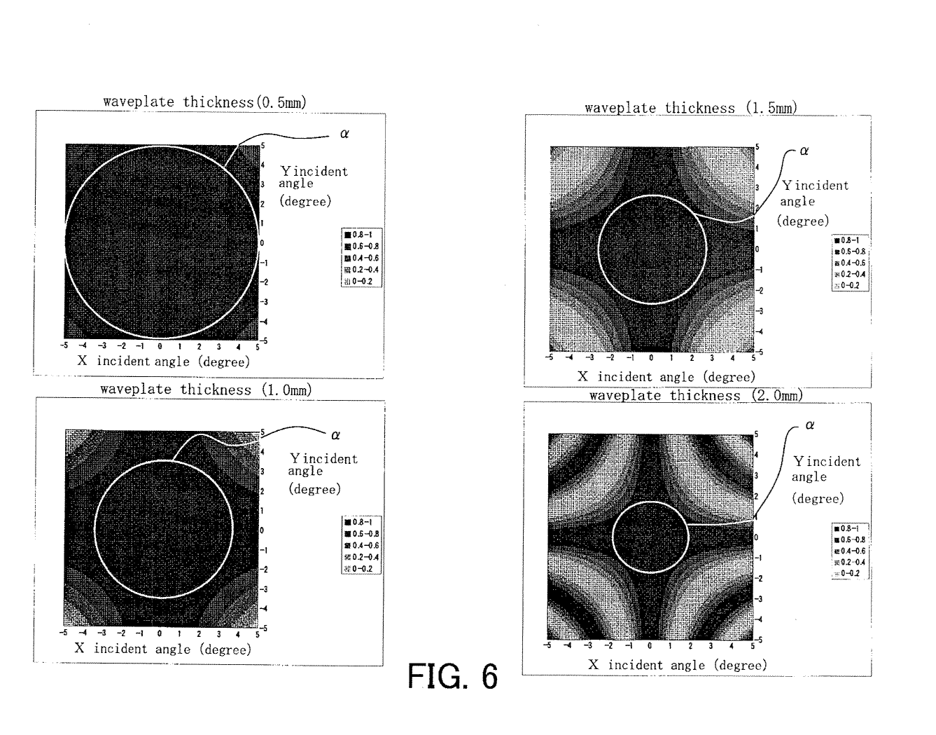

FIG. 6 shows a relationship between the polarization degree and the thickness of the waveplate shown in FIG. 5 (or the thicknesses of d (mm) and d+Δd (mm) of two plates PPa and PPb) In FIG. 6, the abscissa axis denotes the incident angle of the incident light upon the waveplate in the X direction. The ordinate axis denotes an incident angle of the incident light upon of the waveplate in the Y direction. Changes of the polarization degree are indicated by the gray scale. The X direction and the Y direction are orthogonal to each other. Referring to FIG. 6, the phase difference Δ depends upon the incident angle θ and the thickness of the waveplate. As the incident angle increases, and as the waveplate becomes thicker, a change of the polarization degree becomes large.

Accordingly, the waveplate (birefringence Δn(nm/mm)) of this embodiment has a thickness d (mm) that satisfies Equation 2 below to the incident angle θ of the incident light (having a wavelength λ (nm)). The thickness d of the waveplate, as described herein, means that when the waveplate consists of one plate. When the waveplate has two plates, the thickness d of the waveplate indicates a thickness difference between two plates.

$$2.5 \times {10}^{- 7} > \frac{Δ n \times d}{λ} \times ( {sin}^{2} θ \times cos 2 θ / {cos}^{3} θ ) > 0 \qquad Equation 2$$

An area α inside a circle shown in FIG. 6 is an area that meets Equation 2, and a condition that satisfies the polarization degree of 95% or greater.

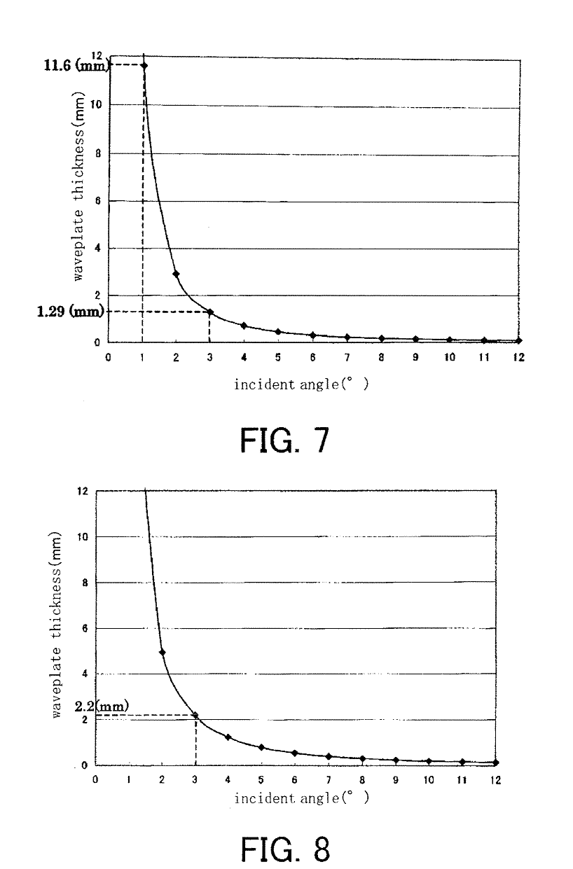

FIG. 7 is a graph showing a relationship between the incident angle and the thickness of the waveplate when Equation 2 is met. This embodiment has the waveplates 114 and 122 that control the polarization state of the light incident upon the effective light source forming unit, and a waveplate 159 that controls the polarization state of the light incident upon the fly-eye lens 151. Since this embodiment sets the incident angle θ of the light incident upon the waveplates 114 and 122 to 1°, the thicknesses of the waveplates 114 and 122 may be maintained to be 11.6 mm or below. Since the incident angle θ of the light incident upon the waveplate 159 is 3.0°, the thickness of the waveplate 159 may be maintained to be 1.29 mm or below. The incident angle θ can be calculated from the actual measurement or the design value of the optical system.

When the waveplate is arranged at a position other than the position of this embodiment, the waveplate may be as thick as or thinner than the thickness determined by the incident angle of the incident light. For example, the polarization illumination having a high polarization degree is available without causing a large polarization shift as long as Equation 2 is met even when a waveplate is arranged at a uniformer pupil part, or on a pupil plane in the illumination or projection optical system.

As understood from Equations 1 and 2, the birefringence Δn of the glass material of the waveplate is also an important parameter that determines the thickness of the waveplate. While this embodiment uses quartz for the glass material of the waveplate with birefringence Δn of 0.01367 nm/cm, another glass material may be used. For example, when the waveplate is located at a position having a larger incident angle, it is conceivable that the waveplate becomes too thin to manufacture. In that case, the waveplate may be made of sapphire with birefringence Δn of 0.008 nm/cm as a glass material having a small birefringence. Thereby, the tolerance zone of the thickness of the waveplate widens, and facilitates the manufacture of the waveplate. FIG. 8 is a graph showing a relationship between the thickness of the waveplate and the incident angle when Equation 2 is met when the glass material of the waveplate is sapphire. Referring to FIG. 7, when the glass material of the waveplate is quartz, the tolerance zone of the thickness of the waveplate is 1.29 (mm) at the incident angle of 3°. On the other hand, referring to FIG. 8, when the glass material of the waveplate is sapphire, the tolerance zone of the thickness of the waveplate is 2.2 (mm) at the incident angle of 3°. In other words, the tolerance zone with sapphire used for the glass material of waveplate is wider than that with quartz.

The glass material of the waveplate needs to be determined in view of the durance of the glass material. When the glass material has low durance, the birefringence varies and the precise waveplate cannot be formed. For example, the waveplate that receives the light having a strong light intensity is preferably made of calcium fluoride or MgF₂ that has high durability.

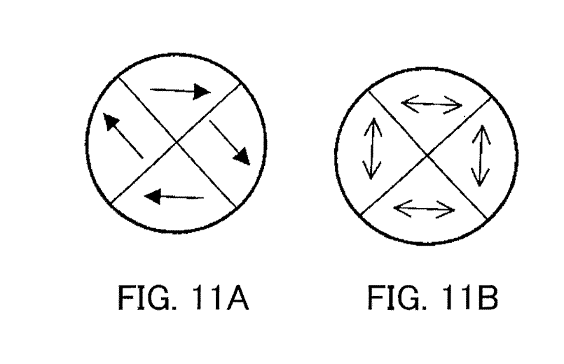

The waveplate 159 is arranged before the fly-eye lens 151, and converts the polarization state of the effective light source to the desired state. The effective light source is a light intensity distribution on the pupil plane in the illumination optical system, and the pupil plane in the illumination optical system of this embodiment is an exit plane of the fly-eye lens 151. FIGS. 10A to 11B are schematic front views of illustrative structure of the waveplate 159. Arrows in FIGS. 10A and 11A denote a fast axis direction of the waveplate 159, and arrows in FIGS. 10B and 11B denote a polarization direction. For example, when the waveplate 159 sets the tangentially polarized light to the effective light source, a combination of eight waveplates shown in FIG. 10A can provide octagonal, tangentially polarized light shown in FIG. 10B to the incident polarized light (or the x-polarized light). When a cross pole illumination needs rectangular, tangentially polarized light, a combination of four waveplates shown in FIG. 11A can provide rectangle, tangentially polarized light shown in FIG. 11B to the incident polarization (x-polarized light). Thus, the waveplate 159 can provide an effective light source to the desired polarization state through a combination of the waveplates even for the illumination mode other than those disclosed in this embodiment.

As described above, the incident angle θ of the light incident upon the waveplate 159 is 3.0°, and this embodiment sets the thickness of the waveplate 159 to 1.00 (mm) so that Equation 2 is met.

The above description assumes that the incident polarized light is the x-polarized light, and the waveplate 159 forms the tangentially polarized light. Alternatively, the incident polarized light may be the y-polarized light, and the radially polarized light (having radial polarization directions) may be formed.

Turning back to FIG. 1, the light shaping unit 130 converts a shape of the light from the light source 12 so that the shape of the light on a predetermined plane (A plane) has a desired shape, such as a circular shape, an annular shape, and a multi-pole shape. The A plane, as used herein, means a plane that forms the basic shape of the effective light source, and the basic shape is converted by the light converter 140. The imaging optical system 145 that makes the magnification variable varies its side, and the stop member, such as the stop 152, arranged at each position forms a desired effective light source on the target plane.

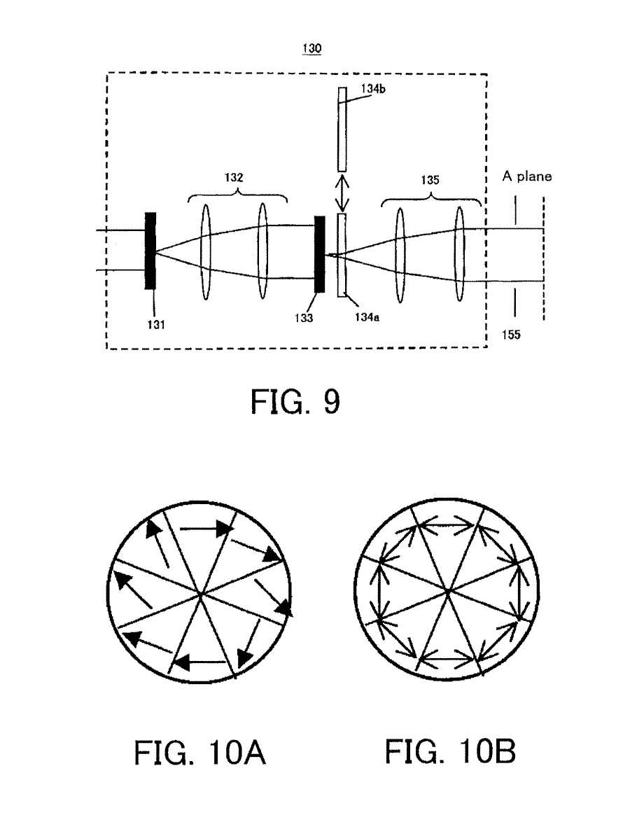

FIG. 9 is a schematic sectional view showing one illustrative structure of the light shaping unit 130. The light shaping unit 130 includes a fly-eye lens, an optical pipe that utilizes internal reflections or a diffraction optical element (“DOE”), plural optical integrators that combines them, a relay optical system, a condenser optical system, and a mirror. The light shaping unit 130 of this embodiment includes optical integrators 131 and 133, optical systems 132 and 135, and DOEs 134a and 134b.

The pattern formed on the A plane is a convoluted pattern between the Fourier transformation pattern formed by the DOE 134a or 134b, and the angular distribution of the light incident upon the DOE 134a or 134b. The Fourier transformation pattern is a pattern formed on the Fourier transformation plane when the light is perpendicularly incident with NA=0.

The DOEs 134a and 134b are configured replaceable with each other. For example, when the DOEs 134a and 134b are replaced, various distributions, such as a circular shape, an annular shape, and a multi-pole shape, can be formed on the A plane. In addition, the DOEs 134a and 134b may provide an intensity in which each pole area in the multi-pole, such as a quadrupole, has a different intensity.

The light shaping unit 130 of this embodiment uses the DOEs 134a and 134b for the unit that forms the effective light source shape, but may use a deflection optical element, such as a prism, to form an effective light source.

The light converter 140 is arranged near the A plane, and further converts the light that has been converted by the light shaping unit 130 to the basic shape. The light converter 140 of this embodiment includes a conical optical element 142, and a conical optical element 144 that can change an interval. The conical optical element 142 has a concave conical incident plane, and a convex conical exit plane and forms, for example, an annular light shape on the A plane. The light converter 140 may have a plane-parallel plate (not shown), a stop member having a proper shape (such as an annular opening, a quadrupole opening, and a circular opening), a pyramid optical element, a roof-shaped optical element, a magnification/reduction beam expander that changes the magnification, etc.

Plural optical elements in the light converter 140 may be switchably arranged on the optical path or plural optical elements may be simultaneously arranged on the optical axis. The optical converter 140 may retreat from the optical path.

The fly-eye lens 151 forms plural light images (effective light source) near the exit plane, and uniformly illuminates the reticle 20. The stop 152 that makes an aperture diameter variable is arranged near a B plane on which plural light source images are formed. However, the position of the stop 152 is not limited to the vicinity of the B plane. For example, the stop 152 may be optically inserted with the light converter 140 into the optical path on the A plane by switching means, such as a turret. The stop 152 may be arranged just before the fly-eye lens 151, or simultaneously arranged at plural positions. For example, a stop that serves to change only an aperture angle of a quadrupole, etc. without restricting the radial direction or a size restricting direction is optionally arranged at a position of the light converter 140. In addition, an iris stop that restricts the size is arranged just before the fly-eye lens 151, and a fixed stop is optionally arranged on the B plane. Thereby, a desired a distribution can be formed. Thus, plural stops that are allotted different functions are arranged at plural positions, and changed or switched so as to realize various σ conditions.

The stop 152 and the aperture stop 32 of the projection optical system 30 are arranged approximately optically conjugate with each other. The shape of the effective light source formed on the aperture stop 32 by fly-eye lens 151 and the stop 152 corresponds to an angular distribution at each point on the wafer 40.

The light among the rays from plural light source images, which is not restricted by the stop 151 effectively illuminates the plane of the masking blade 153 via the condenser optical system 160. The masking blade 153 is arranged optically conjugate with the plane of the reticle 20 via the imaging optical system 170, and defines the target area to be illuminated on the reticle 20 plane.

The condenser optical system 160 of this embodiment includes lenses 162 and 164, and the imaging optical system 170 of this embodiment includes lenses 172 and 174. However, the number of lenses in them is not limited.

A half-mirror 166 is located between the lenses 162 and 164 in the condenser optical system 160. The half-mirror 166 splits the incident light into the reflected light and the transmitting light. This embodiment uses the transmitting light for the illumination light to illuminate the reticle 20, and the reflected light for the detection light to indirectly detect the exposure dose at the detector 70. The half-mirror 166 and the detector 70 is not limited to the arrangement shown in FIG. 1, and may be arranged on the optical path from the light source 12 to the masking blade 153.

The detector 80 is located near the reticle 20 so that the detector 80 is inserted into and removed from the optical path between the reticle 20 and the projection optical system 30.

The filter member 154 is arranged so as to make the transmittance distribution uniform. In other words, the filter member 154 has a transmittance distribution that cancels out an uneven transmittance distribution caused by the transmission film and the reflection film.

The σ shape correction mechanism 155 makes the σ distribution on the target plane conform to the ideal distribution. In particular, in the polarization illumination, the asymmetry of the σ distribution is likely to occur due to the mirror, the half-mirror, and the antireflection film, and thus the σ shape correction mechanism 155 properly adjusts the σ distribution in accordance with a change of the polarization state.

As discussed above, the stress birefringence of the glass material is one factor of the polarization shift, and the exposure apparatus needs a glass material that maintains the stress birefringence low. However, in order to maintain the stress birefringence low, a specific manufacturing step is needed. In addition, the manufacture needs a long time, the yield lowers, and the glass material cost increases. Therefore, in order to compromise the cost reduction of the exposure apparatus and the desired polarization state, it is preferable to change the birefringence standard of the glass material in accordance with the arrangement rather than using the glass material having low stress birefringence for all the optical elements.

The polarization shift in the illumination optical system closer to the reticle 20 than the pupil plane causes a polarization degree distribution in the effective light source, and scattering of the polarization degree between the axial ray and off-axial ray. The polarization degree distribution in the effective light source causes a lateral CD difference and an HV difference. The polarization shift among the image heights generates a axial-off-axial CD difference. Therefore, the glass material in the illumination optical system closer to the reticle 20 than its pupil plane needs to make the birefringence lower than that of the illumination optical system closer to the light source 12 than its pupil plane.

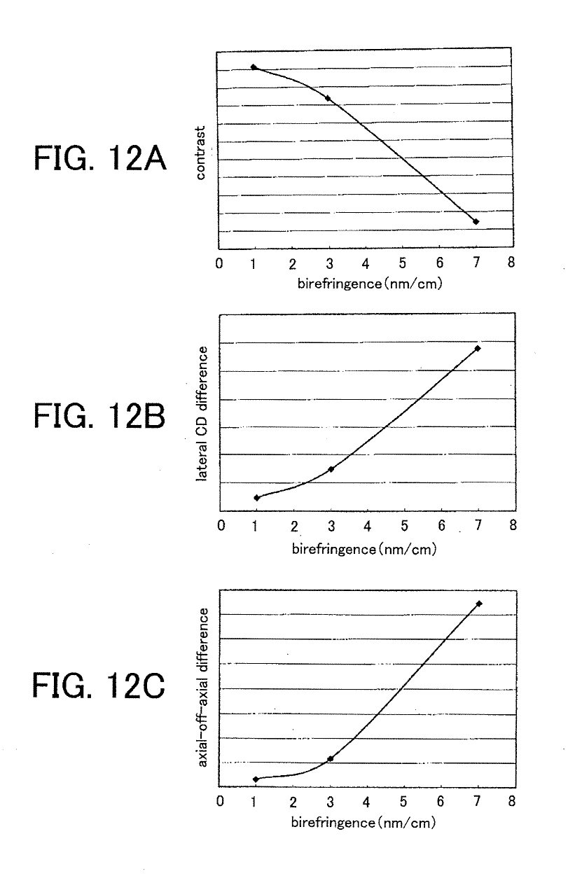

FIG. 12A is a graph showing a change of the contrast in changing the birefringence of the glass material in the illumination optical system closer to the reticle 20 than its pupil plane. FIG. 12B is a graph showing a variance of the lateral CD difference in changing the birefringence of the glass material in the illumination optical system closer to the reticle 20 than its pupil plane. FIG. 12C is a graph showing an axial-off-axial CD difference in changing the birefringence of the glass material in the illumination optical system closer to the reticle 20 than its pupil plane. FIGS. 12A to 12C set the illumination mode to the dipole illumination. Referring to FIGS. 12A to 12C, it is understood that as the birefringence increases, each characteristic deteriorates, such as the contrast, lateral CD difference, and axial-off-axial CD difference. From these results, the birefringence of the glass material subsequent to the pupil plane in the illumination optical system is preferably maintained 2 (nm/cm) or smaller.

On the other hand, the birefringence of the glass material in the illumination optical system closer to the light source 12 than its pupil plane uniformly reduces the polarization degree over the entire pupil plane, but does not depend upon the polarization degree distribution in the effective light source and the polarization degree scattering between the axial ray and the off-axial ray. The glass material in the illumination optical system closer to the light source 12 than its pupil plane may cause a contrast drop, but does not significantly cause deteriorations of the lateral CD difference and axial-off-axial difference. Thus, that does not necessarily require the glass material having low stress birefringence. Therefore, the birefringence of 5 (nm/cm) or smaller is enough for the glass material in the illumination optical system closer to the light source 12 than its pupil plane.

The glass material having the birefringence of 5 (nm/cm) or smaller is less likely to shift the polarization degree, or affect the imaging characteristic. Irrespective of the position, the birefringence of 10 (nm/cm) or smaller is enough.

As discussed above, calcium fluoride or MgF₂ having superior durability is used for the glass material arranged at a position that receives a high light intensity. However, fluoride, such as calcium fluoride, has IBR that causes the polarization shift.

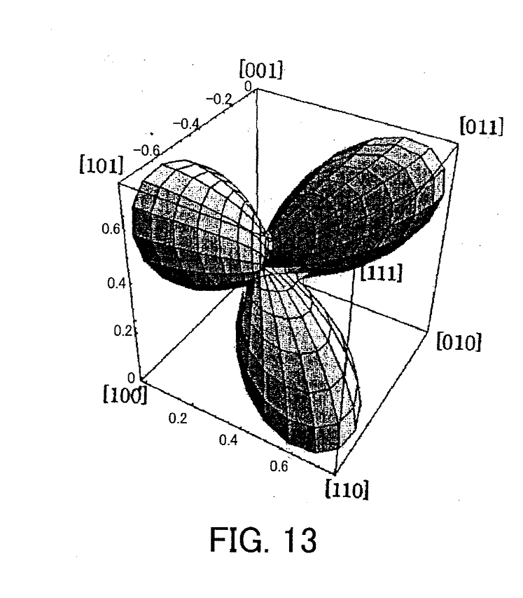

FIG. 13 shows a light's traveling direction dependency upon the IBR of calcium fluoride. The IBR is maintained 0 in the <1 1 1> direction, the <1 0 0> direction, and equivalent directions, and is maximum in the <1 1 0> direction and equivalent directions. In order to reduce the IBR influence, calcium fluoride that is cut along the (1 1 1) plane or (1 0 0) plane or the equivalent plane may be used so that the <1 1 1> direction or the <1 0 0> direction or their equivalent directions accords with or is parallel to the optical axis.

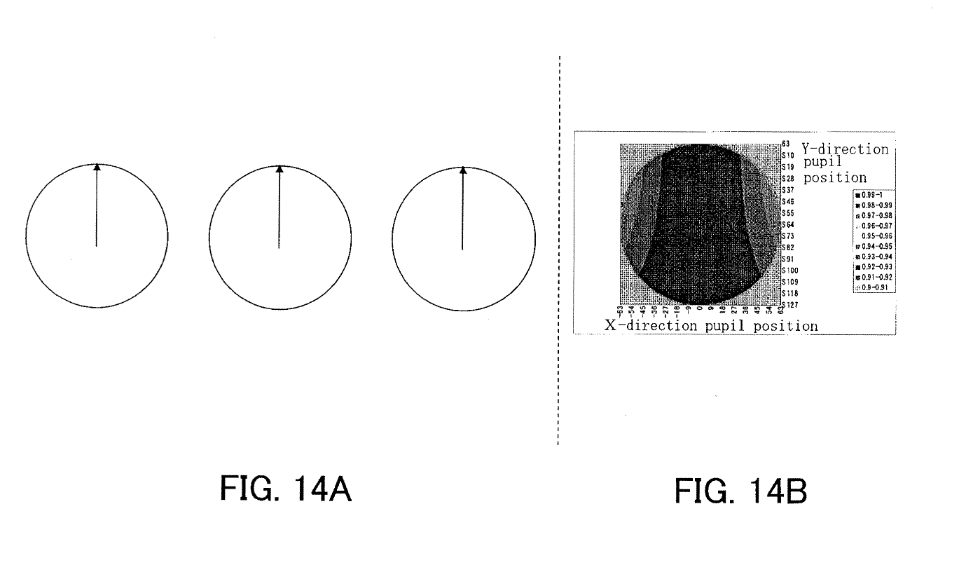

The light incident upon calcium fluoride that has a crystalline azimuth(a crystal axis) in the <1 1 1> direction or the <1 0 0> direction has an angular distribution. Hence, the incident light shifts from the <1 1 1> direction or the <1 0 0> direction, and is subject to the IBR. FIG. 14A is a view of calcium fluoride in which the crystalline azimuth <1 1 1> accords with or is parallel to the optical axis when viewed from the incident direction of the light. The arrow shown in FIG. 14A is a <1 0 0> projected vector, and all <1 0 0> projected vectors of calcium fluoride have the same position. FIG. 14B is a view of the polarization degree in the pupil plane in the illumination optical system or the projection optical system. Is understood from FIG. 14B that the polarization degree locally shifts due to the IBR influence. Since the IBR distribution orientates in the same direction, each glass material has the same position that generates large IBR, and some rays are significantly affected by the IBR whenever passing through the glass material.

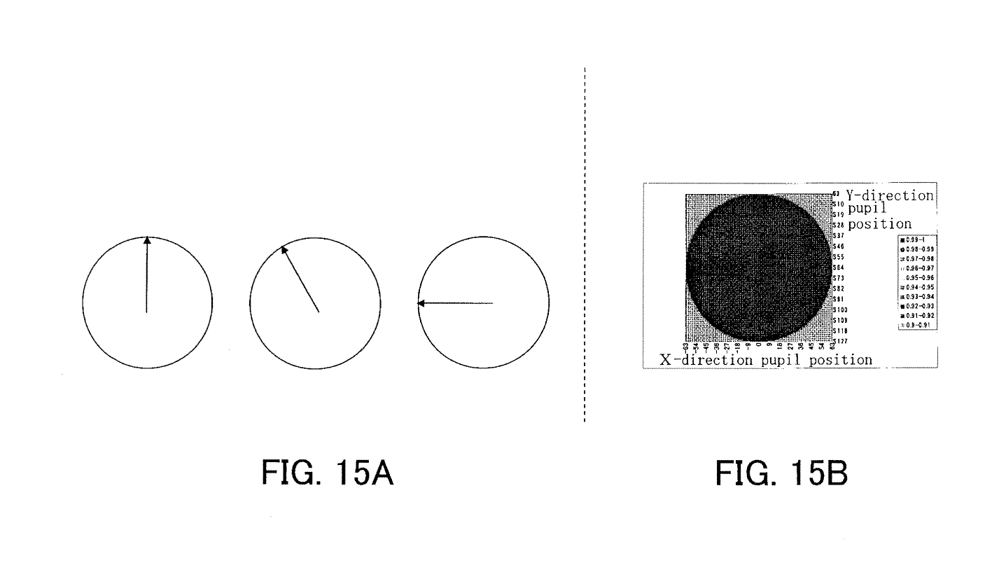

This influence is avoidable when calcium fluoride is properly rotated so that each glass material does not have the same position that generates the large IBR. FIG. 15A shows calcium fluoride having a crystalline azimuth <1 1 1> that is accorded with or parallel to the optical axis when viewed from the light incident direction. The arrow shown in FIG. 15A denotes a <1 0 0> projection vector, and indicates that the <1 0 0> projection vector is different according to calcium fluoride. FIG. 15B shows a polarization degree in the pupil. It is understood from FIG. 15B that the polarization degree does not shift on the entire pupil plane. Thus, the polarization shift reduces through a proper combination of the rotating angles of calcium fluoride.

Even when the crystalline plane and rotating angle of calcium fluoride are optimized, an inclination angle error occurs in arranging calcium fluoride and an angular error occurs in cutting the glass material, causing the polarization shift. The polarization illumination needs to reduce the error factor as small as possible.

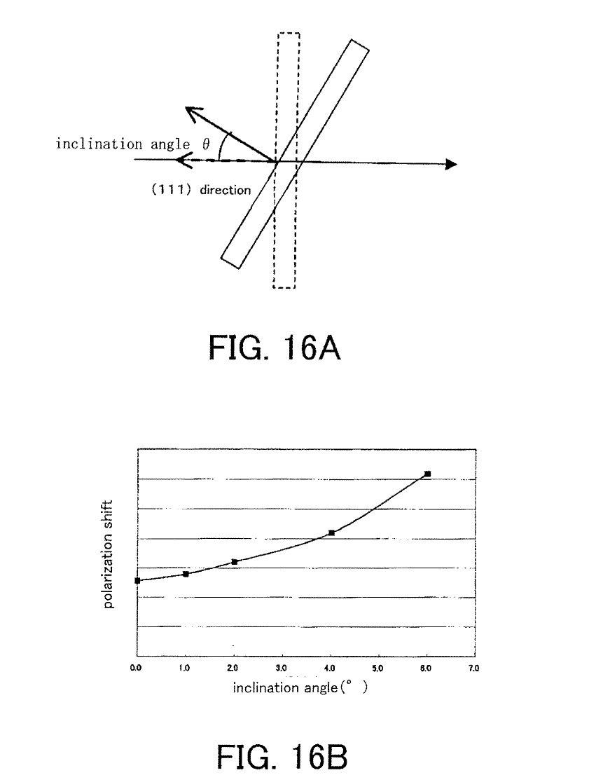

FIG. 16A shows that the crystalline azimuth of calcium fluoride inclines from the <1 1 1> direction or the <1 0 0> direction or the inclination angle error occurs. In FIG. 16A, θ denotes an angle to the <1 1 1> direction or the <1 0 0> direction. FIG. 16B is a graph of the polarization shift amount to the inclination angle error. It is understood from FIG. 16B that as the inclination angle θ increases, the polarization shift amount increases. From FIG. 16B, in the polarization illumination, the inclination angle error of calcium fluoride (glass material) is preferably maintained within ±10°.

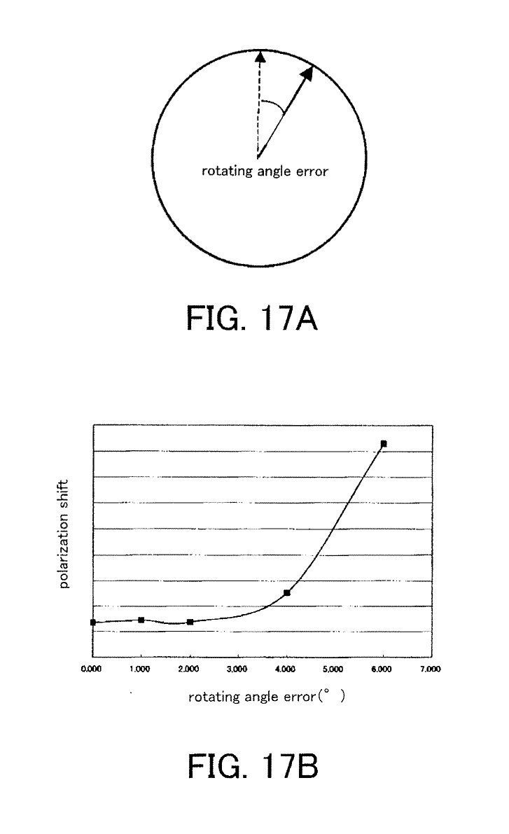

FIG. 17A shows that calcium fluoride shifts from the predetermined rotating angle or the rotating angle error occurs. FIG. 17B shows the polarization shift amount to the rotating angle error. It is understood from FIG. 17B that as the rotating angle error increases, the polarization shift increases. From FIG. 17B, in the polarization illumination, the error of the rotating angle is preferably maintained within ±10°.

A description will now be given of the characteristic of the optical film, such as a reflection film and a transmission film, necessary for the polarization illumination.

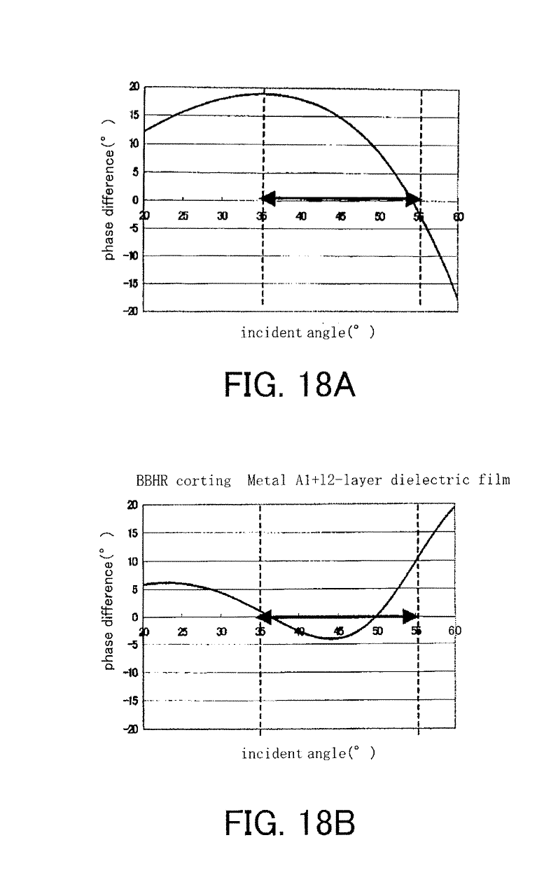

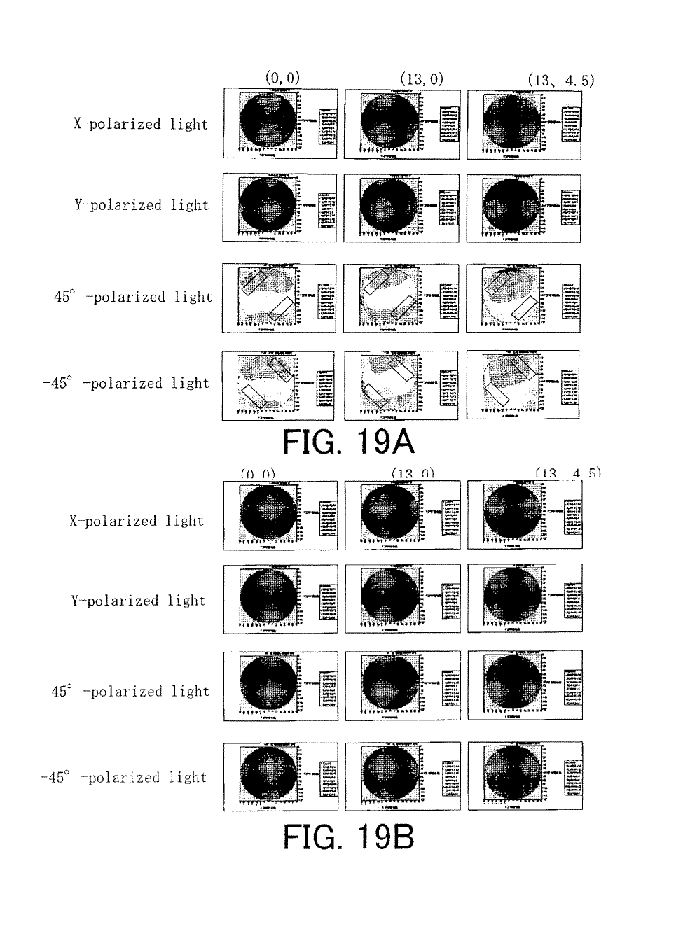

The incident angle of the light incident upon the mirror increases in the illumination optical system closer to the reticle than its pupil plane, and a significant phase difference occurs between the s-polarized light and the p-polarized light to the reflection film on the mirror, causing the polarization shift. Accordingly, in the polarization illumination, the maximum incident angle of the light incident upon the mirror is preferably maintained within 45°±10°. FIG. 18A is a graph showing an angular characteristic of a phase difference of a narrowband high-reflection coating (“NBHR” coating) made of an oxide film used for the non-polarization illumination. FIG. 18B is a graph showing an angular characteristic of a phase difference of a broadband high-reflection coating (“BBHR” coating) made of an Al layer that can maintain a phase difference low through a broadband incident angle.

Referring to FIGS. 18A and 18B, the NBHR coating causes a reflection phase difference of 18°, whereas the BBHR coating reduces a reflection phase difference to 10° relative to the incident angle of 45°±10°.

FIG. 19A is a view showing a result of the polarization shift in the pupil to each polarization direction of the NBHR coating, such as the x-polarized light, the y-polarized light, the 45°-polarized light, and the −45°-polarized light, estimated at image points (0, 0), (13, 0), and (13, 4.5) on the wafer plane. FIG. 19B is a view showing a result of the polarization shift in the pupil to each polarization direction of the BBHR coating, such as the x-polarized light, the y-polarized light, the 45°-polarized light, and the −45°-polarized light, estimated at image points (0, 0), (13, 0), and (13, 4.5) on the wafer plane.

It is understood from FIGS. 19A and 19B that the polarization significantly shifts in the NBHR coating for both the 45°-polarized light and the −45°-polarized light, whereas the polarization shift amount is small in the BBHR coating in each polarization state. Therefore, the BBHR coating that includes an aluminum layer and can restrain the phase difference down to ±10° is preferably used for the reflection film on the mirror in the illumination optical system closer to the reticle than its pupil plane.

In the illumination optical system closer to the light source 12 than its pupil plane, the x-linearly polarized light from the light source 12 is maintained during deflections. As described above, the polarization may shift and the y-polarized light component may occur. In order to maintain the x-polarized light component while reducing the y-polarized light component and restoring the shifted polarization degree, the mirror's reflectance to the s-polarized light is preferably maintained 80% or greater and the mirror's reflectance to the p-polarized light is preferably maintained 30% or smaller. For example, assume that the laser beam having a polarization degree of 95% is reflected on the mirrors four times. The mirror has a reflection film that has such a reflection characteristic that the reflectance to the s-polarized light is 90% and the reflectance to the p-polarized light is 30%. Then, the polarization degree can be restored up to 99.94%. Depending upon the reflection direction, the polarization state of the light incident upon the mirror can be the y-polarized light or the p-polarized light. In this case, the reflectance of the mirror to the p-polarized light is preferably 80% or greater, and the reflectance of the mirror to the s-polarized light is preferably 30% or smaller.

In order to form the effective light source, the illumination optical system closer to the reticle than the pupil plane needs a reflection film having a high reflectance to all the polarization directions. Therefore, the reflectance of the mirror to the s-polarized light is preferably 90% or greater, and the reflectance of the mirror to the p-polarized light is preferably 80% or greater.

The reflectance of the transmission film to each of the s-polarized light and the p-polarized light is preferably maintained 5% or smaller. In addition, the transmission film is preferably configured to have a phase difference within 3%.

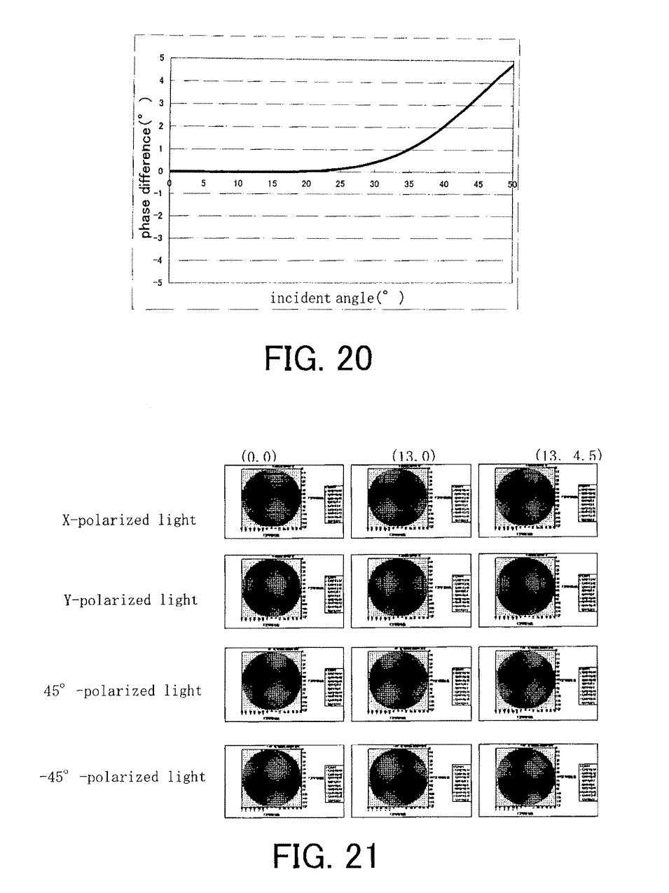

FIG. 20 is a graph showing an angular characteristic of a phase difference of the transmission film. Referring to FIG. 20, this embodiment sets the maximum incident angle to 45°, and the maximum phase difference to 3°.

FIG. 21 shows a result of the polarization shift in the pupil to the transmission film to each polarization direction, the x-polarized light, the y-polarized light, the 45°-polarized direction, and the −45°-polarized direction, at image points (0, 0), (13, 0), and (13, 4.5) on the wafer plane. Referring to FIG. 21, a polarization shift hardly occurs.

Turning back to FIG. 1, the reticle 20 is made of quartz, and has a circuit pattern to be transferred. A reticle stage (not shown) supports and drives the reticle 20.

The projection optical system 30 is an optical system that projects the pattern of the reticle 20 onto the wafer 40. The projection optical system 30 has an aperture stop 32, and can set an arbitrary NA. The aperture stop 32 makes variable the aperture diameter determined by the NA of the imaging light in the wafer 40, and the aperture diameter changes if necessity arises. The coherence factor σ of this embodiment is a ratio between the image size of plural light sources formed by the fly-eye lens 151 at the position of the aperture stop 32 and the aperture diameter of the aperture stop 32.

The B plane (on which plural light sources are formed) and the aperture stop 32 are approximately optically conjugate with each other. Substantially, the distribution on the B plane determines the σ distribution or effective light source on the wafer 40. When the stop 152 is arranged on the B plane, the σ distribution is the distribution that is not restricted by the stop 152. When the stop 152 is arranged on the B plane, and when the fly-eye lens 151 is composed of sufficiently fine lenses (for example, several tens rows or greater in one direction), the substantial σ distribution is the distribution on the incident plane of the fly-eye lens 151 formed via the light shaping unit 130 and the light converter 140.

The projection optical system 30 of this embodiment is a dioptric system that includes plural lenses 34 and 36, but may be a catadioptric optical system or a catoptric optical system. The recent popular immersion lithography fills the liquid, such as pure water, in a space between the final optical element of the projection optical system 30 and the wafer 40. Such a so-called immersion exposure apparatus exposes at a high NA, and a polarization control effect is particularly remarkable.

A substrate of this embodiment is a wafer, but broadly covers a glass plate or another substrate. A photoresist is applied onto the surface of the wafer 40.

The wafer stage 45 supports the wafer 40 via a wafer chuck (not shown). Since the wafer stage 45 can apply any structure known in the art, a description thereof will be omitted.

The controller 60 has a CPU and a memory, and controls the action of the exposure apparatus 1. The controller 60 is connected controllably to each component in the exposure apparatus 1, such as the illumination apparatus 10, the reticle stage, the wafer stage 45, the detectors 70 and 80, and the σ shape correction mechanism 155.

In exposure, the light emitted from the light source 12 illuminates the reticle 20 via the illumination optical system 100. The light that has passed the pattern of the reticle 20 is imaged on the wafer 40 via the projection optical system 30. The exposure apparatus 1 can form a desired polarization state due to the plural waveplates 114, 122, and 159. Since plural waveplates have structures that satisfy Equation 2, the polarization state on the wafer 40 plane can be maintained 80% or greater of the desired polarization state. In addition, in the exposure apparatus 1, the birefringence of the glass material and the characteristic of the optical film, which cause the polarization shift, can maintain the polarization state on the wafer 40 plane of 80% or greater of the desired polarization state. In other words, the exposure apparatus 1 can maintain the polarization state on the wafer 40 plane to the desired state, and can particularly precisely control a polarization state to the light having an NA. Thereby, the exposure apparatus 1 can realize a high resolution and high contrast, and manufacture devices, such as a semiconductor device and a liquid crystal display device, with a high throughput and economical efficiency.

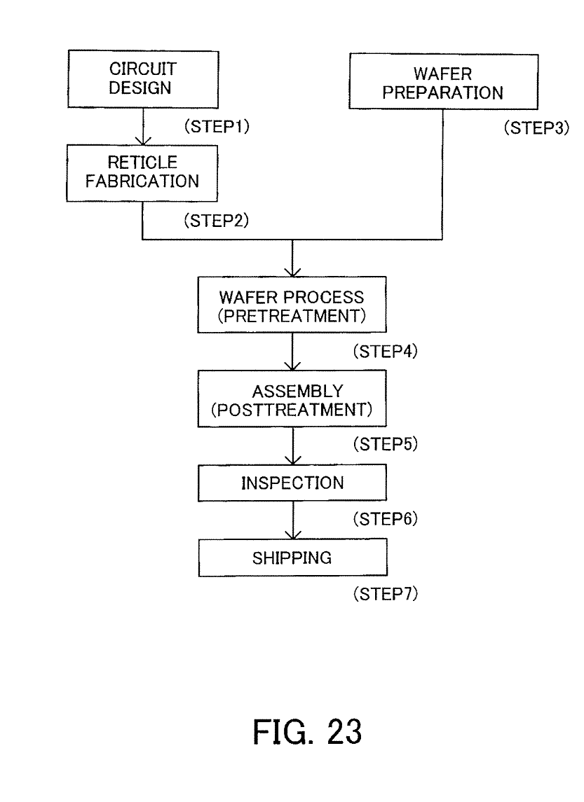

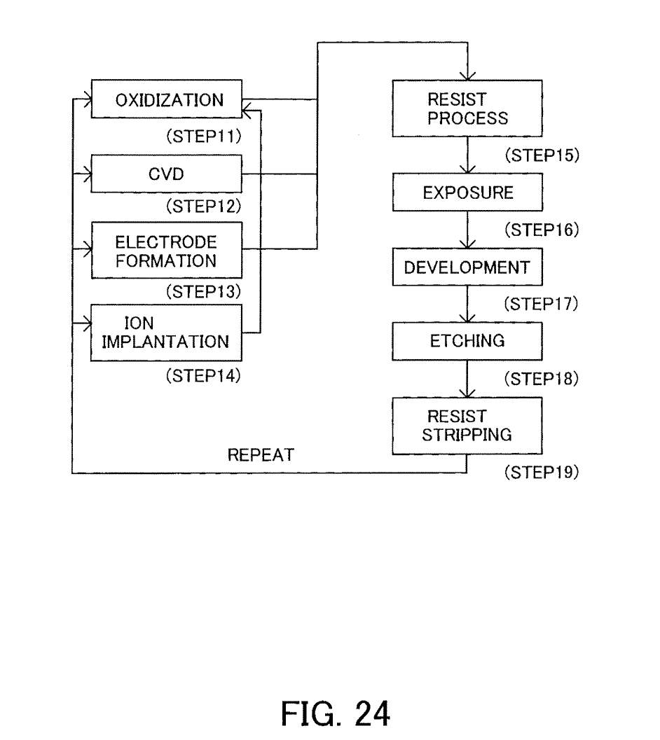

Referring now to FIGS. 23 and 24, a description will be given of a device manufacturing method using the above exposure apparatus 1. FIG. 23 is a flowchart for explaining a fabrication of devices, such as a semiconductor device and a liquid crystal display device. Here, a description will be given of a fabrication of a semiconductor device as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is referred to as a pretreatment, forms actual circuitry on the wafer through photolithography using the reticle and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 24 is a detailed flowchart of the wafer process. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the above exposure method to expose a reticle pattern onto the wafer. Step 17 (development) develops the exposed wafer. Step 18 (etching) etches parts other than a developed resist image. Step 19 (resist stripping) removes disused resist after etching. These steps are repeated, and multilayer circuit patterns are formed on the wafer.

The entire disclosure of Japanese Patent Application No. 2006-083485, filed on Mar. 24, 2006, including claims, specification, drawings, and abstract incorporated herein by reference in its entirety.

As many apparently widely different embodiments of the present invention can be made without departing from the spirit and scope thereof, it is to be understood that the invention is not limited to the specific embodiments thereof except as defined in the claims.

What is claimed:

1. An illumination optical system for illuminating a target plane using light from a light source, the illumination optical system comprising a waveplate that changes a polarization state of the light,
wherein
$$2.5 \times {10}^{- 7} > \frac{Δ n \times d}{λ} \times ( {sin}^{2} θ \times cos 2 θ / {cos}^{3} θ ) > 0$$
is met where λ (nm) is a wavelength of the light, θ is an incident angle of the light incident upon the waveplate, Δn (nm/cm) is birefringence of the waveplate, and d (mm) is a thickness of the waveplate.

2. An illumination optical system for illuminating a target plane using light from a light source, said illumination optical system comprising a waveplate for converting a polarization state of the light, the waveplate including first and second plates,
wherein
$$2.5 \times {10}^{- 7} > \frac{Δ n \times d}{λ} \times ( {sin}^{2} θ \times cos 2 θ / {cos}^{3} θ ) > 0$$
is met where λ (nm) is a wavelength of the light, θ is an incident angle of the light incident upon the waveplate, Δn (nm/cm) is birefringence of the waveplate, and d (mm) is a difference between a thickness of the first plate and a thickness of the second plate.

3. An illumination optical system according to claim 2, wherein the waveplate is located on a pupil plane in the illumination optical system.

4. An illumination optical system according to claim 2, wherein the waveplate includes:
a first waveplate configured to convert the polarization state into a first polarization state; and
a second waveplate configured to converting the first polarization state to a second polarization state different from the first polarization state,
wherein the first and second waveplates are being able to be inserted into and removed from an optical path of the illumination optical system.

5. An illumination optical system according to claim 2, further comprising a depolarization plate configured to eliminate the polarization state of the light, the waveplate being replaceable with the depolarization plate.

6. An illumination optical system according to claim 2, further comprising:
a optical element having a central thickness of 5 mm or smaller and made of a glass material with birefringence of 10 (nm/cm) or smaller,
wherein the glass material having a crystal axis in a (1 1 1) direction or (1 0 0) direction that is parallel to an optical axis direction of the illumination optical system.

7. An illumination optical system according to claim 2, further comprising:
a first optical element located closer to the light source than a pupil in the illumination optical system, and made of a first glass material with birefringence of 5 (nm/cm) or smaller; and
a second optical element located closer to the target plane than the pupil in the illumination optical system, and made of a second glass material with birefringence of 2 (nm/cm) or smaller, the first and the second glass materials having a crystal axis in a (1 1 1) direction or (1 0 0) direction that is parallel to an optical axis direction of the illumination optical system.

8. An illumination optical system according to claim 2, further comprising:
a mirror having a reflection film; and
a lens having a transmission film,
wherein a phase difference between s-polarized light and p-polarized light generated from the light that is incident upon and reflected on the mirror, by the reflection film is within ±10°, and
wherein a phase difference between the s-polarized light and the p-polarized light generated from the light that is incident upon and transmits through the lens, by the transmission film is within ±5°.

9. An exposure apparatus comprising:
an illumination optical system according to claim 2 for illuminating a reticle; and
a projection optical system for projecting a pattern of the reticle onto a substrate.

10. An exposure apparatus according to claim 9, wherein the waveplate is located on a pupil plane in the projection optical system.

11. A device manufacturing method comprising the steps of:
exposing a substrate using an exposure apparatus; and
developing the substrate that has been exposed,
wherein the exposure apparatus includes an illumination optical system, and a projection optical system for projecting a pattern of the reticle onto a substrate, the illumination optical system including a waveplate for converting a polarization state of the light, the waveplate including first and second plates, and
wherein 2.5×10⁻⁷>Δn×d/λ×(sin² θ×cos 2θ/cos³ θ)>0 is met where λ (nm) (nm) is a wavelength of the light, θ is an incident angle of the light incident upon the waveplate, Δn (nm/cm) is birefringence of the waveplate, and d (mm) is a difference between a thickness of the first plate and a thickness of the second plate.
